(19) United States
(12) Patent Application Publication
(10) Pub. No.: US 2026/0284948 A1
(43) Pub. Date: Sep. 24, 2026

(54) A REMOTE-CONTROLLED SMART PLASTIC INJECTION MACHINE

(71) Applicant: TULGA ÜRÜN GELISTIRME MÜHENDISLIK LIMITED SIRKETI, Atasehir/Istanbul (TR)

(72) Inventor: Kenan DÖNMEZ, Atasehir/Istanbul (TR)

(21) Appl. No.: 19/473,750

(22) PCT Filed: May 30, 2023
(86) PCT No.: PCT/TR2023/050490

§ 371 Date: Oct. 8, 2025

(30) Foreign Application Priority Data
Apr. 11, 2023 (TR) 2023/003969

(51) Int. Cl. B29C 45/76; B29C 45/84

(52) U.S. Cl. CPC B29C 45/76; B29C 45/84; B29C 2945/7613; B29C 2945/76153; B29C 2945/76167; B29C 2945/7618; B29C 2945/76257; B29C 2945/76464; B29C 2945/76474

(57) ABSTRACT

The invention relates to a novel remote-controlled smart plastic injection machine that can be used in the office, comprises a plug-in mold assembly system in which the user can produce their own molds, and uses a specially protected plastic raw material cartridge.

### TECHNICAL FIELD

The invention relates to a remote-controlled smart plastic injection machine that can be used in the office, comprises a plug-in mold assembly system in which the user can produce their own molds, and uses a specially protected plastic raw material cartridge.

### STATE OF THE ART

Many production techniques are used for the mass production in the factories that manufacture with the state of the art. In the production of the plastic parts, the volume molding method is generally preferred. The plastic injection/extrusion is a production method which is a sub-step of the volume molding. The plastic injection comprises the steps of injecting the molten plastic raw material into the mold cavity formed from the pre-prepared mold halves, solidifying it by cooling and finally obtaining the product. The plastic injection presses are widely used in the state of the art in the plastics manufacturing sector.

The plastic injection presses started to become widespread in the 1950s with the increasing need for the mass production. It is widely used today, and almost all of the plastic parts are produced by the plastic injection technique. The plastic injection presses consist of a clamp unit, an injection unit and a mold. The classical plastic injection technique comprises the steps of closing, injection, ironing, cooling, opening, and demolding, respectively.

The step of closing comprises the process of clamping the mold halves forming the mold structure to each other with a constant force. In the step of injecting, the injection screw in the injection unit rotates and transfers the molten raw material into the mold. The step of ironing comprises the time required for the molten raw material in the mold to start solidifying under the constant pressure. The step of cooling is the solidification process of the molten raw material. The step of opening comprises that the clamp unit moves away from the injection unit and the mold halves move away from each other.

The step of demolding comprises dropping the plastic part on the other mold half connected to the clamp unit with the help of a pusher.

The plastic injection/extrusion processes comprise the transition of the thermoplastic raw material to the fluid phase when heated, solidifying when cooled, and forming the final part geometry.

The initial investment cost in the injection systems is quite high and the construction takes months. Although the unit cost per piece is very economical when it comes to tens of thousands of prints for the plastic injection molds, the initial investment cost is quite high in low volume production. In recent years, the personalized applications have increased, and the ability to produce in quantities customized for the individuals or usage areas has gained importance, instead of mass production. For this reason, it has become necessary to develop the systems that can quickly and economically produce the plastic parts in low quantities.

In the state of the art in the industry, the volume molds and fully automatic plastic injection presses are used for the needs for the plastic part. The most important factor in these presses and molds is that they can print millions of copies. High printing numbers and mass production demands have made the mentioned production systems uniform and unable to respond to the demands specific to the work and need.

There is a need for a flexible production system that enables the production with a low cost, fast and fully automatic method compared to the existing production solutions for the industries that need the low numbers of plastic parts. In addition, the communication system that allows the remote interventions and the new control mechanisms introduced to the production step have reduced the dependency on the operator.

In the injection machine according to the invention, the mold of a part that can fit into the printing area is provided with only two replaceable mold halves according to the conventional methods, resulting in a structure that is at least ten times more economical and faster. The equivalent systems are in the form of a miniature of the plastic injection presses, and the changes made could not go beyond the size changes.

In the state of the art, the granular raw material has to be taken from the raw material sack with a shovel and loaded into the injection funnel. Even if 100 gr of production is to be made, the unnecessary expenditures arise because the materials are sold in sacks. If the user wants to work with 10 different materials, a large material storage area should be created. Since the plastic granules in the sack become damp over time, the remaining material must be placed in the special dehumidification furnaces to remove moisture.

In the state of the art, the raw materials are taken in sacks, and they are quickly moistened and create the inventory costs. Even if a total production of 100 gr is targeted, it has become a necessity in this system to purchase a minimum of 25 kg raw material sacks.

### OBJECT OF THE INVENTION

The object of the invention is to create a plastic injection molding machine that completely overcomes the above-mentioned problems and provides a fast and flexible production system that can be used even in homes by eliminating the high investment costs required for the classical plastic injection production.

Another object of the invention is to reduce the unit cost per piece in the production of low-volume plastic parts. Selecting the necessary operating conditions (injection parameters) of the system from the library shortens the long commissioning times. The plastic melting unit (extruder) is designed in the most minimal volume, targeting the part volumes of certain sizes. In addition, only two mold halves are sufficient for injection, without the need to use a complete set like the conventional injection molds. Thus, the fast mold binding reduces the library selection and minimal extruder costs.

Another object of the invention is to reveal a system in which the users can make their own plastic injection molds and get their prints.

Another object of the invention is to eliminate the raw material storage problem.

Another object of the invention is to present a sustainable production system by enabling more efficient use of limited raw material resources.

Another object of the invention is to eliminate the need for an operator and to present a fully controlled production system in which all stages can be controlled.

Another object of the invention is to use different types of dehumidified vacuum material cartridges that can be used specifically for the machine, and when the cartridges are inserted into the system, to provide gasket, namely sealing, that provides the airtightness while the system continues to operate. Due to the electronic label/circuit on the material, the system automatically recognizes which material is attached, and automatically transmits the plastic injection parameters specific to that material to the system computer and provides the necessary operating regime.

Another object of the invention is to instantly see the weight of the material in the cartridge with the load cell placed in the cartridge slot, and to inform the user about the total amount of cartridge that will be needed during the process. It is also to reveal a plastic injection machine comprising a structure that sends a warning to the user when the cartridge is about to deplete.

Another object of the invention is to reveal a plastic injection machine that comprises a structure that sends a warning to the user when the cartridge is about to deplete by instantly measuring the level or volume of the granules in the cartridge by connecting with the cartridge light source placed on one side of the cartridge slot and the cartridge photoresistors to be placed on the opposite side.

Another object of the invention is to contain the information about material type, material color, production year, last date of insertion into the system, material weight and material volume on the cartridge electronic label located in the machine, allowing the system to instantly read said information, allowing the user to insert a new cartridge that is about to deplete, and overcoming the raw material inventory cost problem.

Another object of the invention is to reveal a plastic injection machine with a system that can provide the working regime, when necessary, by trying the injection parameters designed for a special need, recording the special parameters that it detects in the system library, and calling them from the library therein.

Another object of the invention is to reveal a plastic injection machine that allows the use of the mold halves produced with the 3D printers such as FDM (Fused deposition modeling) additive manufacturing technique, POLYJET additive manufacturing technique, SLM (selective laser melting) additive manufacturing technique, SLA additive manufacturing technique; the mold halves obtainable by the manufacturing technique with other resin material; and the metal mold halves that can be manufactured by machining with a CNC machine. Two slots are formed in which the injection clamps are placed. Since the mold halves produced with these 3D systems, which are not included in the machine, are of low strength (crushed/breakable) by nature, the mold slots in the clamp are formed to have a strong hold and in a rigid form. Being able to connect the mold halves with 3D technologies provides a comfortable use for home users.

Another object of the invention is to reveal a plastic injection machine configuration that has the mold halves which can be processed quickly by being placed on the plug-in slot on the system, allowing the production with only two mold halves, and also allowing these mold halves to be produced by the end user.

Another object of the invention is to reveal a plastic injection machine configuration with a safety system that provides an automatic stop when possible foreign materials such as residual material or human hands appear in the printing area with an ultrasonic sensor, infrared sensor and/or flight sensor.

Another object of the invention is to reveal a plastic injection machine configuration with a measurement system that provides an automatic stop by learning from the system library the interval at which the mold halves should stop, by measuring the instant distance between the mold halves or the clamp plates with the ultrasonic sensor, infrared sensor and/or flight sensor in the printing area.

Another object of the invention is to reveal a plastic injection machine with a control mechanism allowing the image processing from each print with the image camera located in the print area, providing the instant processing of the data received from the camera, and sending a warning to the user in case of a shape change between two parts or outside the measurement range in the system library.

Another object of the invention is to reveal a plastic injection machine with a structure allowing the temperature change to be observed with the data to be taken from the production area and from each part with the thermal camera located in the printing area, and sending a warning to the user when the data received from the thermal camera is processed instantly and is out of the range in the system library.

Another object of the invention is to reveal a plastic injection machine comprising a camera or cameras that allows/allow the instant measurement of whether there is an undesirable situation in production after each printing, such as not being able to print the part, not obtaining the desired geometric dimensions, etc., and that can continue to work without the need for an operator. The system computer processes these data with the photogrammetry method and interprets the required geometrical measurements simultaneously. If the received data is processed instantly and is out of the range in the system library, the user is warned.

Another object of the invention is to reveal a plastic injection machine configuration comprising a system that informs the user with a warning system which instantly monitors the ideal voice level limits in the system library in case of a possible problem in the working conditions with the microphone measuring the decibel level in the printing area, and that allows a manual or remote access when the voice goes out of the decibel range.

Another object of the invention is to reveal a plastic injection machine configuration comprising a system that informs the user with a warning system which measures the weight of the part coming out after the injection with the load cell located under the clamp area, compares the weight of the part that should be seen on the system computer, and allows a manual or remote access when the weight of the part goes out of range.

Another object of the invention is to reveal a plastic injection machine comprising a control panel/screen/mechanism that allows the user to read the instant production information, see and hear the production area without the need to go near the machine, allows the user to stop and restart processes, when necessary, without having to go near the production system, and in which the instant information can be exchanged with the smart tablet, PC and phone with the remote access protocol in the system computer.

### DESCRIPTION OF THE FIGURES

FIG. 1 Perspective View of the Smart Plastic Injection Machine (Closed)

FIG. 2 Perspective View of the Smart Plastic Injection Machine (Open)

FIG. 3 Exploded View of the Cartridge Section

FIG. 4 Front View of the Cartridge Section

FIG. 5 Detailed View of the Cartridge Section

FIG. 6 Detailed View of the Cartridge Section

FIG. 7 Exploded View of the Smart Plastic Injection Machine

FIG. 8 Perspective View of the Production Area

FIG. 9 Detailed View of the Production Area

FIG. 10 Detailed View of the Subsection of the Production Area

FIG. 11 Front View of the Production Area (Sectional)

FIG. 12 Detailed View of the Mold Section of the Production Area

FIG. 13 Front View of the Printing Elements of the Production Area

FIG. 14 Detailed View of the Mold Section of the Production Area

FIG. 15 Detailed View of the Mold Section of the Production Area

FIG. 16 Perspective View of the Printing Elements of the Production Area

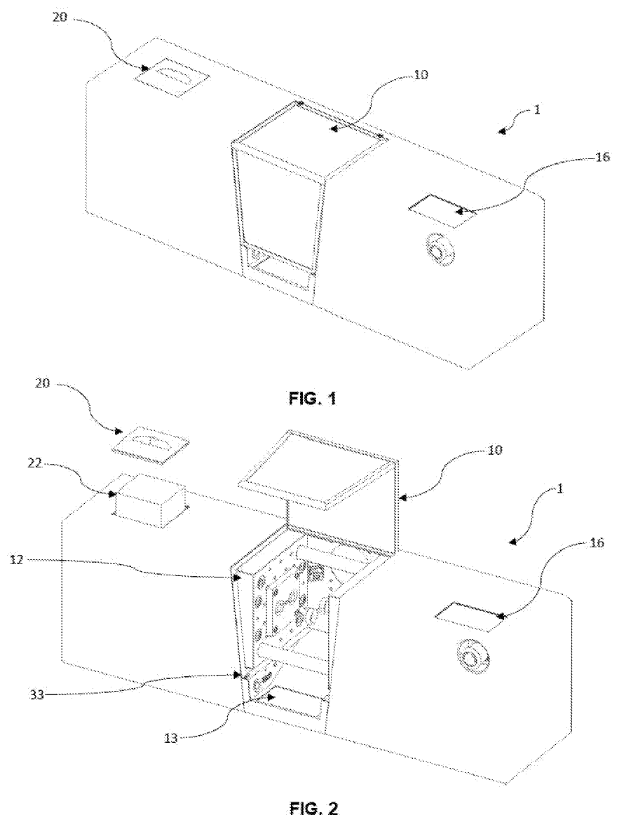

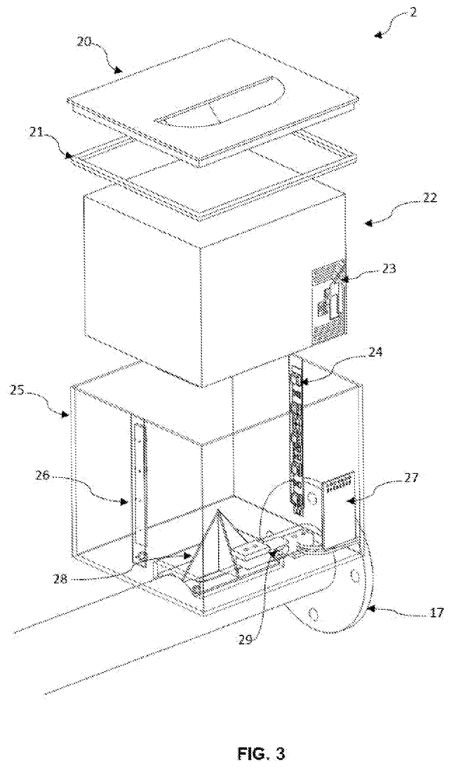

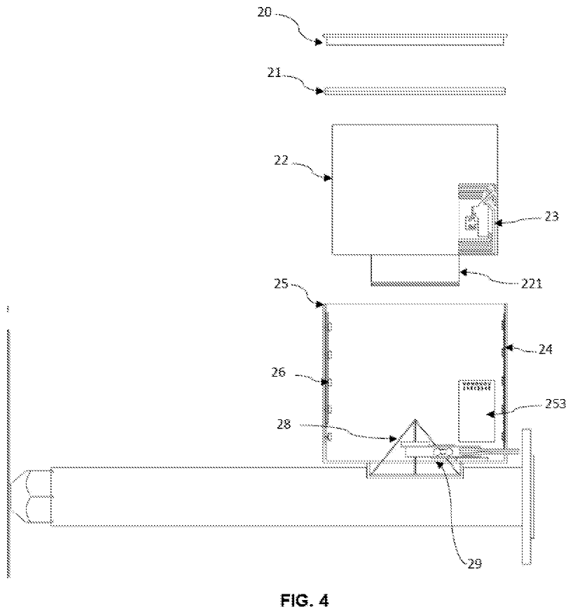

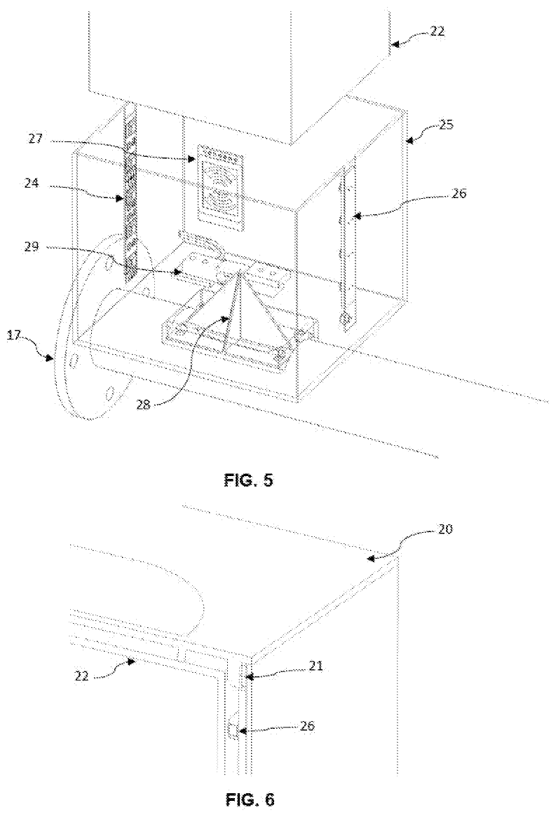

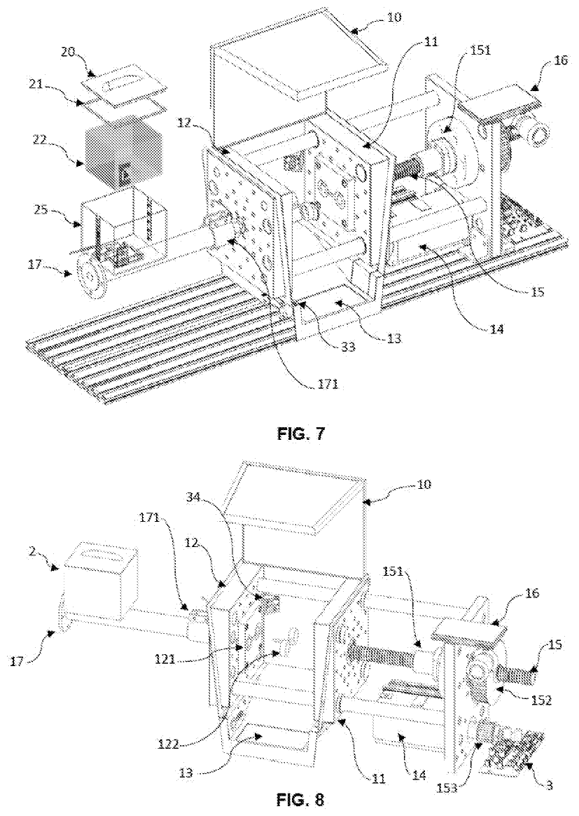

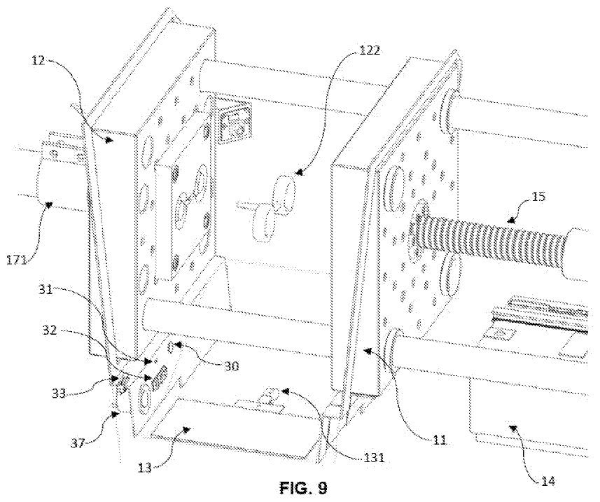

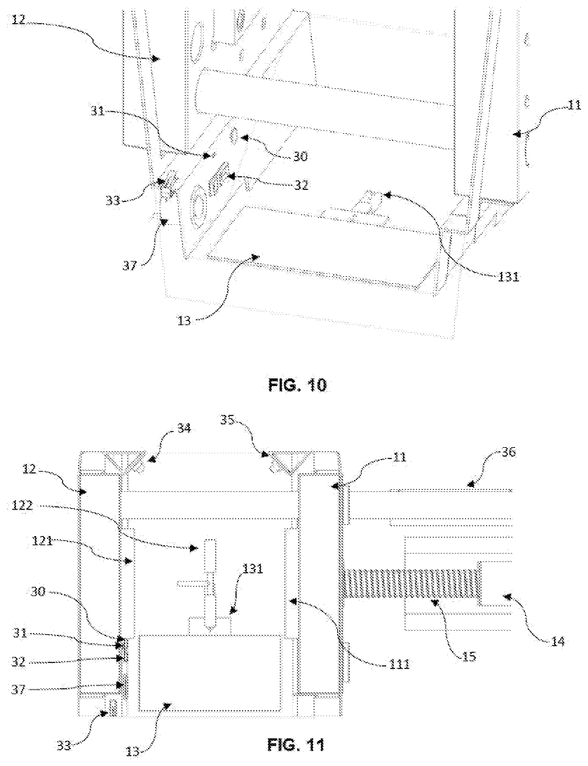

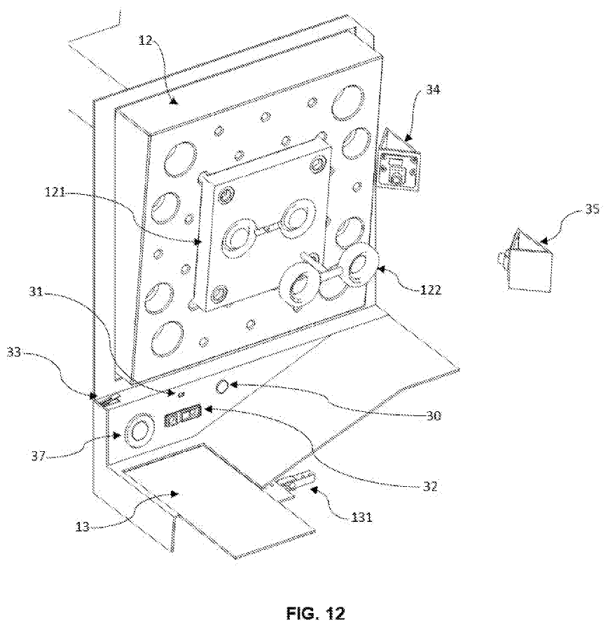

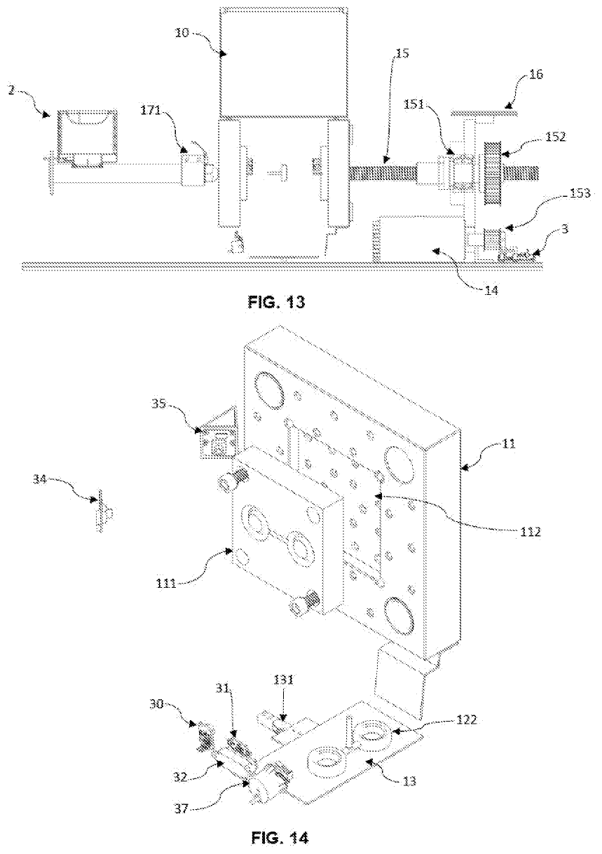

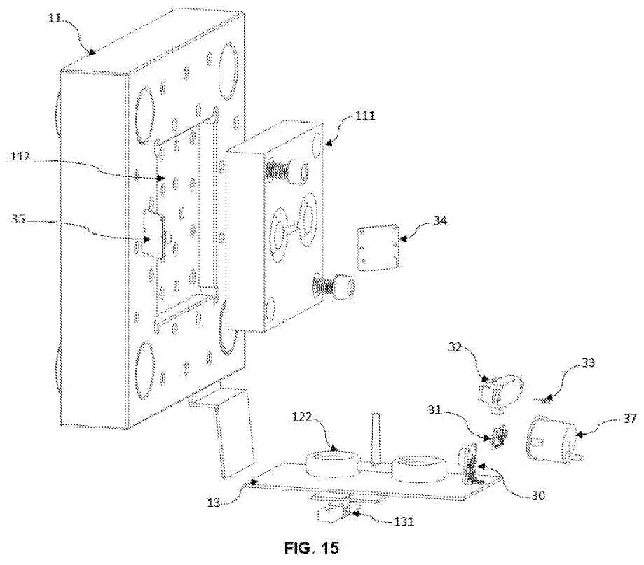

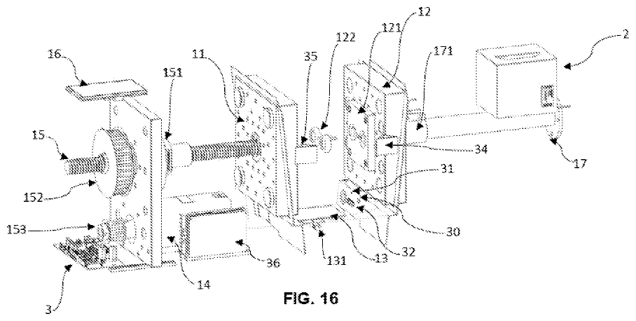

### DESCRIPTION OF THE REFERENCE NUMBERS IN THE FIGURES

1—Injection Machine
2—Cartridge Section
3—System Computer
10—System Cover
11—Movable Clamp Plate
12—Fixed Clamp Plate
13—Scale Plate
14—Motor
15—Shaft
16—Screen
17—Extruder Sleeve
20—Cartridge Cover
21—Gasket
22—Cartridge
23—Electronic Label
24—Photoresistor
25—Cartridge Slot
26—Light Source
27—Electronic Label Reader
28—Cartridge Blade
29—Cartridge Load Cell
30—Flight Sensor
31—Voice Sensor
32—Infrared Sensor
33—Mechanical Switch
34—Camera
35—Thermal Camera
36—Control Unit
37—Ultrasonic Sensor
111—Movable Mold Half
112—Plug-In Mold Slot
121—Fixed Mold Half
122—Part
131—Scale Load Cell
151—Radial Bearing
152—First Motion Transmission Element
153—Second Motion Transmission Element
171—Heater
221—Package

### DETAILED DESCRIPTION OF THE INVENTION

The invention relates to a plastic injection machine (1), wherein it comprises
at least one communication module (not shown in the figures) which allows all modules in the injection machine (1) to communicate with each other via sensors and to transmit the information such as the collected voice, part geometry, image, distance, temperature, etc. instantly to at least one system computer (3),
at least one control unit (36) which has at least one cartridge slot (25) in which at least one cartridge (22) is connected to the machine in at least one package (221) comprising at least one electronic label (23) with the information about raw material weight, raw material production date, raw material expiry date, and the last injection date with the raw material, the information about how much weight and volume of material remains in the raw material, the information about raw material color, and raw material producer, the information about the suitable injection system and mold material to be used, and comprises at least one cartridge load cell (29) that measures the weight of the loaded raw material, and at least one screen (16) connected therein and monitoring all production parameters simultaneously via an electronic label (23) and simultaneously processing the updated information on the electronic label (23), and providing the instant exchange of information with the devices such as smart tablet, PC and phone via a system computer (3) in which the 3D CAD model and/or volume information of the part to be produced is entered, and a remote access protocol contained in said system computer (3),
at least one production area module (not shown in the figures) comprising at least one production area system cover (10) in which the entire production area region can be viewed and which contains all the production mechanisms, at least one controller (not shown in the figures) that prevents the movement against the possible tampering when a system cover (10) is opened, at least one mechanical switch (33) located under the production area cover, at least one camera (34) which monitors inside the production area and allows the image processing from each print, at least one thermal camera (35) which detects the temperature change, at least one infrared sensor (32) which detects the substances that may enter between the two molds, at least one ultrasonic sensor (37) which detects the transparent objects, at least one flight sensor (time of flight sensor/ToF) (30) which measures the reflections, at least one plug-in mold slot (112) consisting of at least one movable clamp plate (11) and at least one fixed clamp plate (12), into which at least two molds, including at least one movable mold half (111) and at least one fixed mold half (121) are inserted, at least one voice sensor (31) which measures the decibel level within the printing area, at least one extruder sleeve (17) comprising at least one heater (171) with the resistors thereon, and at least one scale plate (13) with at least one balance scale cell (131) on which the printed parts (122) are collected and simultaneously weighed,
at least one safety module (not shown in the figures) which provides an automatic stop by warning in the case of the appearance of the possible foreign materials such as residual material or human hands via the ultrasonic sensor (37), infrared sensor (32) and flight sensor (30) located in the printing area,
a motion drive module (not shown in the figures) having at least one ball screw (15) to which the extruder sleeve (17) is connected and which takes the raw material at the beginning of the cartridge (22) and transmits it with its rotational movement to the fixed mold half placed on the fixed clamp plate (12) and which allows the movable plate and thus the mold half fixed thereto to approach the fixed mold half (121) by the linear motion, at least one radial bearing (151) on the ball screw (15), at least one first motion transmission element (152) and at least one second motion transmission element (153) consisting of gears and providing the motion transmission by cooperating with said radial bearing (151), and at least one motor (14) providing the motion drive of said structure.

The plastic injection machine (1) according to the invention must be loaded with the raw materials for at least one part (122) to be manufactured. The plastic raw materials are released at low weights and in a vacuum package (221) in a ready-to-use state. Said vacuum packages (221) on the surface of said cartridge (22), together with the electronic labels (23) thereon, are realized in the cartridge section (2) which consists of the cartridges (22) used from the machine according to the invention. The material cartridge (22) is inserted into the cartridge slots (25) located in the printing area within the production area of the plastic injection machine (1). The electronic label (23) located on the cartridge (22) inserted into the cartridge slot (25) comprises the information about the production parameters of the material, injection parameters, production and expiry date of the raw material, the last injection date with the raw material, raw material color, raw material producer, suitable injection system, raw material weight, the information about how much weight and volume of raw material remains in the cartridge (22) and the information about the mold material to be used. Thus, when the cartridge (22) is inserted into the cartridge slot (25), the electronic label reader (27) communicates with the system computer (3) located in the control module of the plastic injection machine (1), and this information is transferred to the system computer (3). The system computer (3) simultaneously monitors all said parameters over the electronic label (23), and simultaneously processes the updated information on the electronic label (23).

The plastic injection machine (1) according to the invention comprises at least one cartridge blade (28) which allows the cartridge (22) to be filled into the cartridge slot (25) by tearing the vacuum package (221).

The cartridge slot (25) into which the cartridge (22) is inserted comprises a weight-measuring cartridge load cell (29). Said cartridge load cell (29) communicates with the system computer (3) during the production and transmits the information about how much raw material remains in the cartridge (22), thus it is determined when the new cartridges (22) need to be installed for ongoing production, and the user is informed via the remote communication devices or via the screen (16) on the control unit (36). In the case that the updated material amount does not change during the production or the electronic label (23) and the system computer (3) cannot communicate, the plastic injection machine (1) according to the invention gives a warning and the system goes into a standby mode.

The cartridge (22) located in said cartridge section (2) is a part of the plastic injection machine (1) according to the invention and is configured under the cartridge cover (20) on the machine. Said cartridge cover (20) can be opened and closed by the user for the replacement of the cartridge (22). A sealing is provided by a gasket (21) which provides the airtightness between the cartridge (22) and the cartridge cover (20) while the system continues to operate when the cartridges (22) are inserted into the system by the user. By connecting with at least one cartridge light source (26) placed on one side of the cartridge slot (25) and at least one cartridge photoresistor (24) placed on the opposite side, the level or volume of the granules in the cartridge (22) is instantly measured and reported to the user. Thus, a warning can be sent to the user when the cartridge (22) is about to deplete.

The production area comprises the printing area under the production area system cover (10). There is a mechanical switch (33) providing the system to be stopped, when necessary, with the information from the controllers under the system cover (10), which prevents the movement against the possible tampering, and from the sensors located in the production area. Thus, the possible work accidents are prevented. The camera (34) located in the production area takes the image of the entire production area and enables the image processing from each print. The thermal camera (35) detects the temperature change. The infrared sensor (32) located in the printing area detects the substances that may enter between the two molds. The flight sensor (30) measures the reflections in the printing area. Thus, a multiple control is provided within the production area. These multiple controllers located in the printing area collect the information such as voice, part geometry, image, distance and temperature, etc. occurring in the printing area and transmit it to the system computer (3) instantly. Thus, when the values are out of the programmed range, the plastic injection machine (1) according to the invention gives a warning and even stops the production when necessary. Each part produced is instantly measured in terms of geometry, volume and weight. Since the problems in the production are mostly noticed when the movable mold half (111) is connected, all conditions between two printings are controlled in this system and a warning is given in the case of an undesired result.

The mode of operation of the plastic injection machine (1) according to the invention and the interaction of its elements are as follows:

The movable mold half (111) and the fixed mold half (121) of the plastic part to be produced are fixed to the plug-in mold slot (112) by the user. Then, the user inserts the raw material cartridge (22) to be used into the cartridge slot (25). The 3D CAD model and/or volume information of the part to be produced is entered into the system computer (3) via the screen (16) on the control unit (36) located in the control module of the plastic injection machine (1) according to the invention. Then the selected 3D mold material is entered into the system computer (3). The system computer (3) interprets the information read from the electronic label (23) on the selected cartridge (22), the mold material and the 3D CAD model and interprets the production parameters such as the injection speed, injection temperature, injection pressure, ironing time, mold opening time, and automatically selects the ideal conditions from its library so that the plastic injection machine (1) according to the invention becomes ready for printing. Then, the user starts the cycle from the screen (16) on the control unit (36). With the start of the cycle, the raw material in the material cartridge (22) is conveyed to the extrusion sleeve (17). The heater (171) on the extrusion sleeve (17) starts to warm up and brings the raw material to the melting point. The motor (14), to which the extruder sleeve (17) is connected, takes the raw material at the beginning of the cartridge (22) and transmits it with its rotational movement to the fixed mold half (121) placed on the fixed clamp plate (12). The movable clamp plate (11) and the other movable mold half (111) fixed thereto make a linear motion with the radial bearing (151) located on the ball screw (15) and approach the fixed mold half (121). The contact of the two molds with each other is detected by the sensors in the printing area and this information is transmitted to the system computer (3). The system computer (3), which interprets the system parameters, calculates the required mold closing force and transmits the necessary compression (press) force to the ball screw motor (14), and receives the information of the ball screw motor (14), and a mold cavity is formed so that there is no leakage of the plastic part by locking the mold halves together. The injection nozzle, which is ready for printing, provides the flow of the molten plastic raw material in the extruder sleeve (17) through the fixed clamp plate (12) into the mold cavity. The required printing volume is filled by the system. This volume information comes from the system computer (3) which interprets the system parameters. When the required volume is reached, the extruder sleeve (17) applies a constant holding torque and the ironing phase begins. During the ironing phase, the molds are cooled with air or liquid. When the mold opening time is reached, the movable clamp plate (11) is opened. The solidified plastic part (122) is measured by the system computer (3) with the data from the camera (34) located in the printing area. It then falls into the chamber under the plastic injection machine (1) with the effect of gravity. The printed parts are weighed simultaneously with the scale load cell (131) located in the lower chamber. The injection conditions and environment are simultaneously interpreted by the system computer (3) and if there is no problem, the printing of the second part is started. Thus, a printing cycle is completed. During the production, the plastic injection machine (1) simultaneously records whether the production area system cover (10) is open, allowing the user to observe the operations in the printing area, whether there is a foreign/undesirable material (residual material or human hands) in the injection area, the ambient temperature of the injection area, the accuracy of the dimensions of the manufactured part, the decibel value that occurs during the production, the distance between the molds, the position information of the movable elements, the material weight in the cartridge (22), and the weight of the printed part, and forms an event log in its library. The user can instantly and remotely hear and control these data collected from the injection machine (1) according to the invention. The system is remotely controllable.

### INDUSTRIAL APPLICABILITY OF THE INVENTION

The invention relates to a plastic injection machine (1) used in the plastic product manufacturing method and is industrially applicable.

The invention is not limited to the above exemplary embodiments and the person skilled in the art can readily present different embodiments of the invention. These should be considered within the protection scope of the invention claimed by the claims.

1. A plastic injection machine (1), characterized in that it comprises
at least one communication module which allows all modules in the injection machine (1) to communicate with each other via sensors and to transmit the information such as the collected voice, part geometry, image, distance, temperature, etc. instantly to at least one system computer (3),
at least one control unit (36) which has at least one cartridge slot (25) in which at least one cartridge (22) is connected to the machine in at least one package (221) comprising at least one electronic label (23) with the information about raw material weight, raw material production date, raw material expiry date, and the last injection date with the raw material, the information about how much weight and volume of material remains in the raw material, the information about raw material color, and raw material producer, the information about the suitable injection system and mold material to be used, and comprises at least one cartridge load cell (29) that measures the weight of the loaded raw material, and at least one screen (16) connected therein and monitoring all production parameters simultaneously via an electronic label (23) and simultaneously processing the updated information on the electronic label (23), and providing the instant exchange of information with the devices such as smart tablet, PC and phone via a system computer (3) in which the 3D CAD model and/or volume information of the part to be produced is entered, and a remote access protocol contained in said system computer (3),
at least one production area module comprising at least one production area system cover (10) in which the entire production area region can be viewed and which contains all the production mechanisms, at least one controller (not shown in the figures) that prevents the movement against the possible tampering when a system cover (10) is opened, at least one mechanical switch (33) located under the production area cover, at least one camera (34) which monitors inside the production area and allows the image processing from each print, at least one thermal camera (35) which detects the temperature change, at least one infrared sensor (32) which detects the substances that may enter between the two molds, at least one ultrasonic sensor (37) which detects the transparent objects, at least one flight sensor (30) which measures the reflections, at least one plug-in mold slot (112) consisting of at least one movable clamp plate (11) and at least one fixed clamp plate (12), into which at least two molds, including at least one movable mold half (111) and at least one fixed mold half (121) are inserted, at least one voice sensor (31) which measures the decibel level within the printing area, at least one extruder sleeve (17) comprising at least one heater (171) with the resistors thereon, and at least one scale plate (13) with at least one balance scale cell (131) on which the printed parts (122) are collected and simultaneously weighed,
at least one safety module which provides an automatic stop by warning in the case of the appearance of the possible foreign materials such as residual material or human hands via the ultrasonic sensor (37), infrared sensor (32) and flight sensor (30) located in the printing area,
a motion drive module having at least one ball screw (15) to which the extruder sleeve (17) is connected and which takes the raw material at the beginning of the cartridge (22) and transmits it with its rotational movement to the fixed mold half placed on the fixed clamp plate (12) and which allows the movable plate and thus the mold half fixed thereto to approach the fixed mold half (121) by the linear motion, at least one radial bearing (151) on the ball screw (15), at least one first motion transmission element (152) and at least one second motion transmission element (153) consisting of gears and providing the motion transmission by cooperating with said radial bearing (151), and at least one motor (14) providing the motion drive of said structure.

2. An injection machine (1) according to claim 1, characterized in that the cartridge section (2) comprises
at least one cartridge cover (20) which can be opened and closed by the user for the replacement of the cartridge (22),
a gasket (21) which provides the airtightness between the cartridge (22) and the cartridge cover (20) while the system continues to operate when the cartridges (22) are inserted into the system by the user,
at least one cartridge slot (25), into which the cartridges (22) are inserted, providing the integration into the system,
at least one cartridge (22) inserted into the cartridge slot (25),
at least one vacuum package (221), located on the surface of the cartridge (22) and allowing the plastic raw materials to be released at low weights and in a ready-to-use state,
at least one cartridge blade (28) which allows the cartridge (22) to be filled into the cartridge slot (25) by tearing the vacuum package (221),
at least one electronic label (23), located on the cartridge (22) and comprising the information about the production parameters of the material, injection parameters, production and expiry date of the raw material, the last injection date with the raw material, raw material color, raw material producer, suitable injection system, raw material weight, the information about how much weight and volume of raw material remains in the cartridge (22) and the information about the mold material to be used,
at least one cartridge load cell (29) which measures the weight in the cartridge slot (25) into which the cartridge (22) is inserted, communicates with the system computer (3) during the production, transmits the information about how much raw material remains in the cartridge (22), determines when the new cartridges (22) need to be installed for ongoing production, and allows the user to be informed via the remote communication devices or via the screen (16) on the control unit (36),
at least one cartridge light source (26) located on one side of the cartridge slot (25) and allowing the level or volume of the granules in the cartridge (22) to be instantly measured and reported to the user by establishing a connection, and at least one cartridge photoresistor (24) to be placed on the opposite side.

3. An injection machine (1) according to claim 1, characterized in that it comprises at least one mechanical switch (33) providing the system to be stopped, when necessary, with the information from the controllers in the printing area, under the system cover (10), which prevents the movement against possible tampering, and from the sensors located in the production area.
